(19) United States
(12) Patent Application Publication
(10) Pub. No.: US 2006/0062304 A1
(43) Pub. Date: Mar. 23, 2006

(54) Apparatus and method for error concealment

(76) Inventor: Shih-Chang Hsia, Yuanlin Township (TW)

Correspondence Address: GLENN PATENT GROUP, 3475 EDISON WAY, SUITE L, MENLO PARK, CA, 94025, US

(21) Appl. No.: 10/944,079

(22) Filed: Sep. 17, 2004

(51) Int. Cl. H04N 11/02; H04N 7/12; H04N 11/04; H04B 1/66

(52) U.S. Cl. 375/240.16; 375/240.27; 375/240.2; 375/240.24; 375/240.12

(57) ABSTRACT

The present invention provides an apparatus and a method for error concealment. The control core receives an input signal and identifies an error macro-block in a column of slice of a frame and a frame type of the frame. The parameter computation module receives a plurality of DCT coefficients and temporal data to derive at least a coefficient for the weighting in an adaptive computation for the frame. The temporal compensation module computes the temporal data to obtain a result of the temporal compensation. The spatial processing module computes spatial data to obtain a result of the spatial processing. The adaptive processing module proceeds the adaptive computation with the coefficient for the weighting derived by the parameter computation module, the result of the temporal compensation and the result of the spatial processing, and generates a result of the adaptive processing. The spatial processing may be a bilinear interpolation or a spatial interpolation.

### FIELD OF THE INVENTION

The present invention relates to an apparatus and method for error concealment, and more particularly, to an apparatus and method for error concealment for video transmission.

### BACKGROUND OF THE INVENTION

Recently, the compressed video delivery over the error-prone environment is growing rapidly. For example, MPEG-2 and H. 263 coding systems have been widely applied in digital TVs, video-on-demands, video-conferencing and multimedia communications. However, the coded video is very sensitive to channel errors due to variable length coding (VLC). Since the receiver needs to decode the VLC codeword sequentially, non-correctable VLC codes often lead to errors of subsequent data. The decoding error is not only in the current block but also in the next blocks until the next re-synchronization point. The minimum synchronization point is often set to be a GOB (Group of Macro-blocks) for H. 263 system or a Slice for MPEG-2. The bit-stream errors may lead to information loss in partial or entire Slice (or GOB) and cause the sudden degrading of the image quality. Moreover, the errors would be propagated into the entire GOP (Group of Pictures) coding due to motion compensation.

### SUMMARY OF THE INVENTION

Hence, an objective of the present invention is to provide an apparatus and method for error concealment which adaptively combines the results of the spatial processing and the temporal compensation based on block variance and inter-frame correlation to correct the error data.

Another objective of the present invention is to provide an apparatus and method for error concealment in which the adaptive function depends on the scene change detection, motion distance and spatial information from the nearby blocks of the previous and current frames to determine the weighting of the spatial processing and the temporal compensation.

According to the aforementioned objectives, the present invention provides an apparatus for error concealment. The apparatus comprises a control core, a parameter computation module, a temporal compensation module, a spatial processing module, and an adaptive processing module. The control core receives an input signal and identifies an error macro-block in a column of slice of a frame and a frame type of the frame. The parameter computation module receives a plurality of DCT coefficients and temporal data to derive at least a coefficient for the weighting in an adaptive computation for the frame. The temporal compensation module computes the temporal data to obtain a result of the temporal compensation. The spatial processing module computes spatial data to obtain a result of the spatial processing. The adaptive processing module proceeds the adaptive computation with the coefficient for the weighting derived by the parameter computation module, the result of the temporal compensation and the result of the spatial processing, and generates a result of the adaptive processing.

In the preferred embodiment of the present invention, the apparatus further comprises a multiplexer for outputting a normal pixel, or the result of the temporal compensation, the result of the spatial processing, or the result of the adaptive processing as a corrected pixel in the error macro-block. The apparatus further comprises at least a buffer to store the spatial data and at least a register to store the temporal data.

The present invention provides a method for error concealment. The method comprises the following steps. First, an input signal is received and an error macro-block in a column of slice of a frame and a frame type of the frame are identified. Then, a plurality of DCT coefficients is extracted from a decoder and temporal data is accessed to derive at least a coefficient for the weighting in an adaptive computation for the frame. The temporal data is computed to obtain a result of the temporal compensation, and spatial data is computed to obtain a result of the spatial processing. Afterwards, the adaptive computation is proceeded with the coefficient for the weighting, the result of the temporal compensation and the result of the spatial processing, and a result of the adaptive processing is generated.

In the preferred embodiment of the present invention, the method further comprises outputting a normal pixel, or the result of the temporal compensation, the result of the spatial processing, or the result of the adaptive processing as a corrected pixel in the error macro-block. The method further comprises inputting a plurality of macro-blocks of a next column of slice when the error macro-block is computed.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates the boundary search to find the best match between the bottom block B_{B} and the top blocks B_{TL}, B_{T} and B_{TR};

FIG. 2a and FIG. 2b illustrates the error concealment with weighting interpolation from the best match boundary with top-to-bottom block searching and bottom-to-top block searching, respectively;

FIG. 3 illustrates the processing flow of the full system;

FIG. 4 illustrates the relative motion prediction for error concealment;

FIG. 5 illustrates the frequency distribution in a DCT block;

FIG. 6 illustrates the apparatus for error concealment of the preferred embodiment of the present invention;

FIG. 7 illustrates the computation schedule of the spatial processing;

FIG. 8 illustrates the implementation of the present invention in an error concealment chip; and

FIG. 9 illustrates the test structure of the preferred embodiment of the present invention.

### DETAILED DESCRIPTION OF THE PREFERRED EMBODIMENT

In order to make the illustration of the present invention more explicit and complete, the following description is stated with reference to the accompanying drawings.

The present invention provides an apparatus and a method for error concealment. The control core receives an input signal and identifies an error macro-block in a column of slice of a frame and a frame type of the frame. The parameter computation module receives a plurality of DCT coefficients and temporal data to derive at least a coefficient for the weighting in an adaptive computation for the frame. The temporal compensation module computes the temporal data to obtain a result of the temporal compensation. The spatial processing module computes spatial data to obtain a result of the spatial processing. The adaptive processing module proceeds the adaptive computation with the coefficient for the weighting derived by the parameter computation module, the result of the temporal compensation and the result of the spatial processing, and generates a result of the adaptive processing. The spatial processing may be a bilinear interpolation or a spatial interpolation.

The following will detaily describe the spatial interpolation and the temporal compensation disclosed in the present invention.

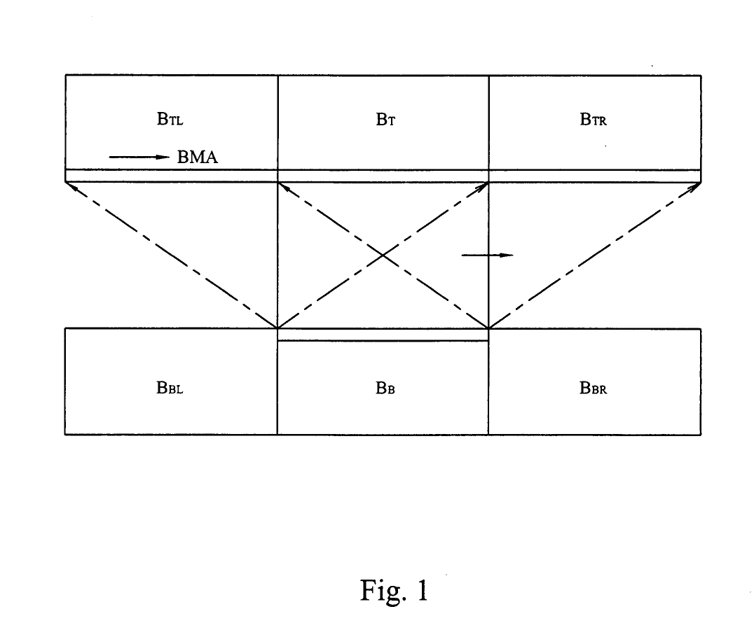

A spatial interpolation technique is provided to recover the damages suffered by continuous blocks. First, 1-D block boundary matching is employed between the neighboring blocks to find the edge direction for a lost block. Then, the recovered pixel is interpolated along the edge direction based on the estimated result. FIG. 1 illustrates the boundary search to find the best match between the bottom block B_{B} and the top blocks B_{TL}, B_{T} and B_{TR}, where B_{TL}, B_{T} and B_{TR} denote the top-left, the top, and the top-right blocks. The 1-D boundary matches with the mean absolute difference (MAD) as expressed by equation (1):

$$MAD ( Mx ) = {\sum }_{i = 0}^{N - 1} \vert {f}_{0 , i}^{{B}_{B}} - {f}_{N - 1 , i + Mx}^{{B}_{TL} , {B}_{T} , {B}_{TR}} \vert , \qquad ( 1 )$$

where Mx is a search vector that is from −N to N if the block size is N×N. Then, the best match (BMA) corresponding to the minimum MAD value can be obtained as
BMA=Min. (MAD(Mx)), Mx from −N to N. (2)

After comparing 2N MADs, the best vector can be found that matches the block B_{B} and the blocks B_{TL}, B_{T} and B_{TR} in boundary. The best vector can give direction to the edge for the lost block. If the edge direction is 0°˜45°, the best match should be located between the blocks B_{T} and B_{TR}. On the other hand, if the edge direction is 90°˜135°, the best match could be found between the blocks B_{TL} and B_{T}.

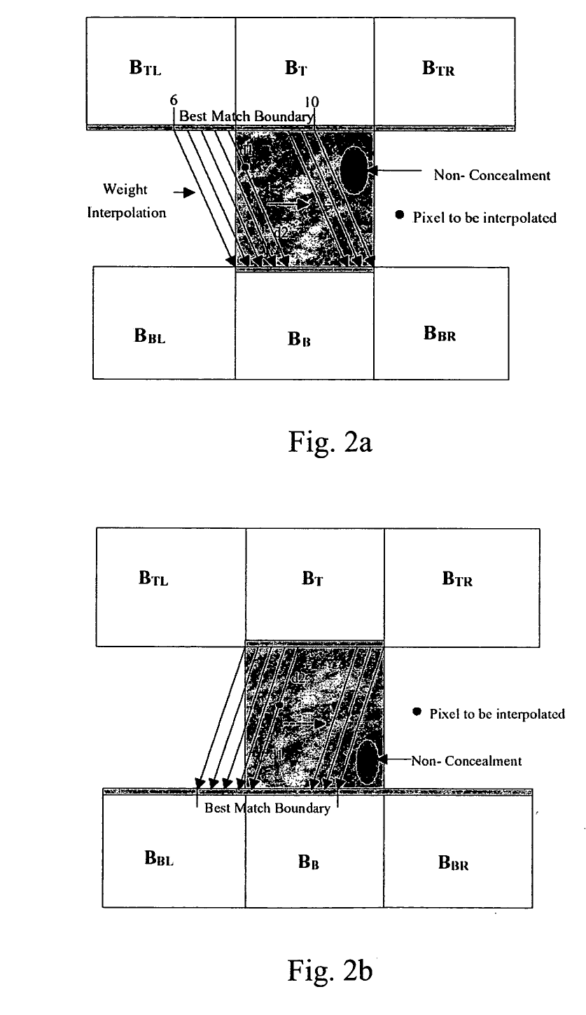

If the estimated result BMA value is less than one threshold, this implies that there exists a significant edge or a smooth area between the neighboring blocks. In this case, the lost pixels are interpolated along the direction of the best vector. FIG. 2a shows the interpolation direction as the vector Mx=−6. If one direction line contains M pixels to be interpolated, this can be computed using

$${\hat{f}}_{m1 , n1}^{1} = {f}_{N - 1 , i}^{{B}_{TL} , {B}_{T} , {B}_{TR}} \times \frac{d2}{M} + {f}_{0 , k}^{{B}_{B}} \times \frac{d1}{M} \qquad ( 3 )$$

where d1 and d2 are the distances between the interpolated pixel to the best matching boundary and to the bottom block, respectively. If the location of the interpolated pixel is closer to the bottom block, the weighting of the boundary pixel of block B_{B} is increased since d1 becomes larger. N lines are needed to interpolate for a lost block along the best matching boundary to recover some significant edges.

Then, the top block B_{T} is used to find the best vector among the bottom blocks B_{BL}, B_{B} and B_{BR} with the boundary matching, where B_{BL}, B_{B} and B_{BR} denote the bottom-left, the bottom, and the bottom-right blocks. By the same procedure above, the best vector can be found after 2N MAD computations. Then, the pixel is interpolated along the best matching boundary as

$${\hat{f}}_{m2 , n2}^{2} = {f}_{0 , i}^{{B}_{BL} , {B}_{B} , {B}_{BR}} \times \frac{d1}{M} + {f}_{N - 1 , k}^{{B}_{T}} \times \frac{d2}{M} . \qquad ( 4 )$$

The interpolation direction is shown in FIG. 2b.

Then, the lost pixel is recovered from the merging of the results of (3) and (4). If the interpolated pixel is overlapped, the results of (3) and (4) are averaged using

$$If {f}_{m1 , n1}^{1} \neq 0 and {f}_{m2 , n2}^{2} = 0 , {\hat{f}}_{m , n} = {f}_{m1 , n1}^{1} \\ Elseif {f}_{m1 , n1}^{1} = 0 and {f}_{m2 , n2}^{2} \neq 0 , {\hat{f}}_{m , n} = {f}_{m2 , n2}^{2} \\ Elseif {f}_{m1 , n1}^{1} \neq 0 and {f}_{m2 , n2}^{2} \neq 0 , {\hat{f}}_{m , n} = \frac{{f}_{m1 , n1}^{1} + {f}_{m2 , n2}^{2}}{2} \qquad ( 5 )$$

where the error pixel level is set to zero. Since the neighboring blocks have high correlation about the edge information, most of the lost pixels can be efficiently recovered along the edge direction with the proposed matching or interpolating scheme. However, a few pixels are not interpolated after the two-direction interpolations. The non-linear median filter is used to interpolate the residual un-recovered pixels to avoid blurring the images. To improve performance, overlapping block processing can be employed rather than the median filter. The overlapping scheme takes the match and interpolations like the above mentioned method between two block-boundaries.

For the temporal compensation, the purpose is to find an accuracy motion vector from the available neighboring blocks of the current and reference frames rather than motion estimation in the decoder. As the true motion vector is (Mvx, Mvy) and the recovered vector at the decoder is (Mv\hat{x}, Mvŷ), the error distance (ED) is computed as
ED=\sqrt{(Mvx-Mv\hat{x})²+(Mvy-Mvŷ)²}. (6)
Error concealment technique of the present invention aims to find a vector with the minimum ED at the decoder and then to obtain better results.

First, compute the temporal distance among the available neighboring blocks of the current and reference frames. The relative neighboring blocks of the lost block is as shown in FIG. 1, where B_{T}, B_{B}, B_{TL}, B_{TR}, B_{BL} and B_{BR} denote the top, the bottom, the top-left, the top-right, the bottom-left, and the bottom-right blocks, respectively. Since the motion vectors of neighboring blocks are available, the temporal distance (TD) of the top blocks is first estimated as
TD_{T}=\sqrt{(Mvxₜ^{B}^{_{T}}-Mvxₜ₋₁^{B}^{_{T}})²+(Mvyₜ^{B}^{_{T}}-Mvyₜ₋₁^{B}^{_{T}})²}, (7)
where Mvxₜ^{B}^{_{T}} and Mvxₜ₋₁^{B}^{_{T}} denotes the motion vector of the current and previous frame at the top block. By the same way, the temporal distance of the bottom, the top-left, the top-right, the bottom-left, and the bottom-right blocks that are named as TD_{B}, TD_{TL}, TD_{TR}, TD_{BL} and TD_{BR}, respectively, can also be found. If the temporal distance of neighboring blocks is smaller, this implies that the linear motion or zero motion exists between the current block and the previous block. The linear motion means that the current block and the previous block have the same motion vector. In order to make sure the linear motion exist, the multi-direction approach is used to check the temporal distance. The local temporal distances (LTD) of the left side and the right side for the lost block are computed by
LTD_{Left}=Σ(TD_{TL},TD_{T},TD_{BL},TD_{B}),
LTD_{right}=Σ(TD_{T},TD_{TR},TD_{BR},TD_{B}). (8)
Since the linear motion may occur in other directions, the local temporal distances for the right-bottom and the left-bottom denoted LTD_{right-bottom} and LTD_{left-bottom} are calculated by parameters (TD_{TR},TD_{BR},TD_{B},TD_{BL}) and (TD_{TL},TD_{BR},TD_{B},TD_{BL}), respectively. Similarly, the local temporal distances for the top-left LTD_{top-left} and the top-right LTD_{top-right} corners are individually computed by using (TD_{TL},TD_{T},TD_{TR},TD_{BL}) and (TD_{BR},TD_{TL},TD_{T},TD_{TR},). Afterwards, the local temporal distance for the lost block is estimated by the minimum value of (LTD_{left}, LTD_{right}, LTD_{right-bottom}, LTD_{left-bottom}, LTD_{top-left}, LTD_{top-right}). If the estimated LTD value is less than one threshold, the linear motion or zero motion is confirmed. The motion vector of previous frame MVxₜ₋₁^{C} can be used for calculating the motion vector of the current lost block. If the estimated LTD value is greater than the threshold, this implies that there are large motion deviations between the current and previous frames at the lost block local area, and therefore, the temporal vector cannot be used.

If the LTD value is greater than the threshold, the motion vector from neighboring blocks of the current frame is estimated for the lost block. The vector distance (VD) of left side is computed by

$${VD}_{left} = \sqrt{{( {Mv}_{t}^{{B}_{TL}} - {Mv}_{t}^{{B}_{T}} )}^{2} + {( {Mv}_{t}^{{B}_{T}} - {Mv}_{t}^{{B}_{B}} )}^{2} + {( {Mv}_{t}^{{B}_{B}} - {Mv}_{t}^{{B}_{BL}} )}^{2} + {( {Mv}_{t}^{{B}_{BL}} - {Mv}_{t}^{{B}_{TL}} )}^{2}} \qquad ( 9 )$$

Similarly, we can compute parameters VD_{right} by using the vectors of the top, the top-right, the bottom-right and the bottom blocks. The vector distances VD_{right-bottom}, VD_{left-bottom}, VD_{top-left}, VD_{top-right} and VD_{right} are computed for the other directions to find a possible motion direction with the current frame information. The local vector distance (LVD) for the lost block is estimated by
LVD=Min. (VD_{left},VD_{right},VD_{right-bottom},VD_{left-bottom},VD_{top-left},VD_{top-right}) (10)
If the LVD is less than a threshold, this implies that the local area has the same motion vector. The motion vector for the lost block is attained from the average of four vectors with the minimum distance. For example, if the VD_{left} has the minimum distance, the motion vector for the lost block is estimated from

$$MV ( \hat{x} , \hat{y} ) = ( \frac{{Mvx}_{t}^{{B}_{TL}} + {Mvx}_{t}^{{B}_{T}} {Mvx}_{t}^{{B}_{B}} + {Mvx}_{t}^{{B}_{TL}}}{4} , \frac{{Mvy}_{t}^{{B}_{TL}} + {Mvy}_{t}^{{B}_{T}} + {Mvy}_{t}^{{B}_{B}} + {Mvy}_{t}^{{B}_{TL}}}{4} ) . \qquad ( 11 )$$

This is one of the methods to obtain the motion vector for the lost block in the present invention.

However, if the local temporal distance and the local vector distance are all larger than thresholds, the motion vector of the lost block cannot be estimated in accuracy since the correlation of the neighboring blocks in the current and previous frames is very low. Thus, the average vector of the current and previous frames is used from

$$MV ( \hat{x} , \hat{y} ) = ( \frac{{Mv}_{t}^{{B}_{TL}} + {Mv}_{t}^{{B}_{T}} + {Mv}_{t}^{{B}_{TR}} + {Mv}_{t}^{{B}_{BR}} + {Mv}_{t}^{{B}_{B}} + {Mv}_{t}^{{B}_{BL}} + 2 {Mv}_{t - 1}^{{B}_{C}}}{8} ) , \qquad ( 12 )$$

to achieve an averaged result.

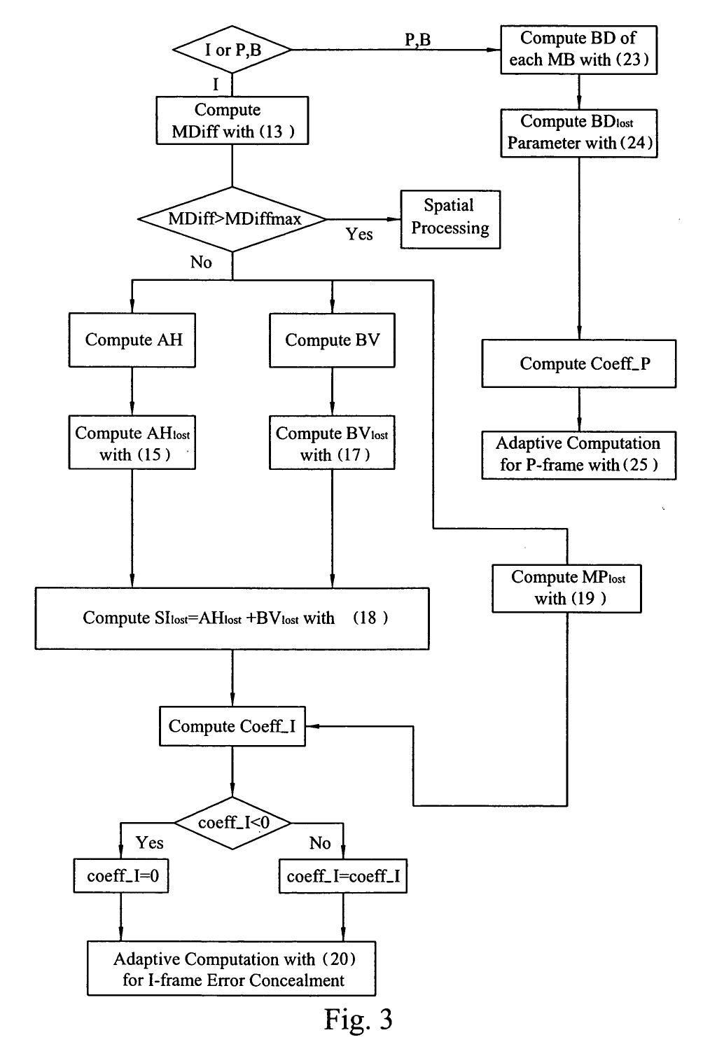

The error concealment of the intra-frame (I-frame), P-frame and B-frame will be described in the following with reference to FIG. 3 illustrating the processing flow of the full system.

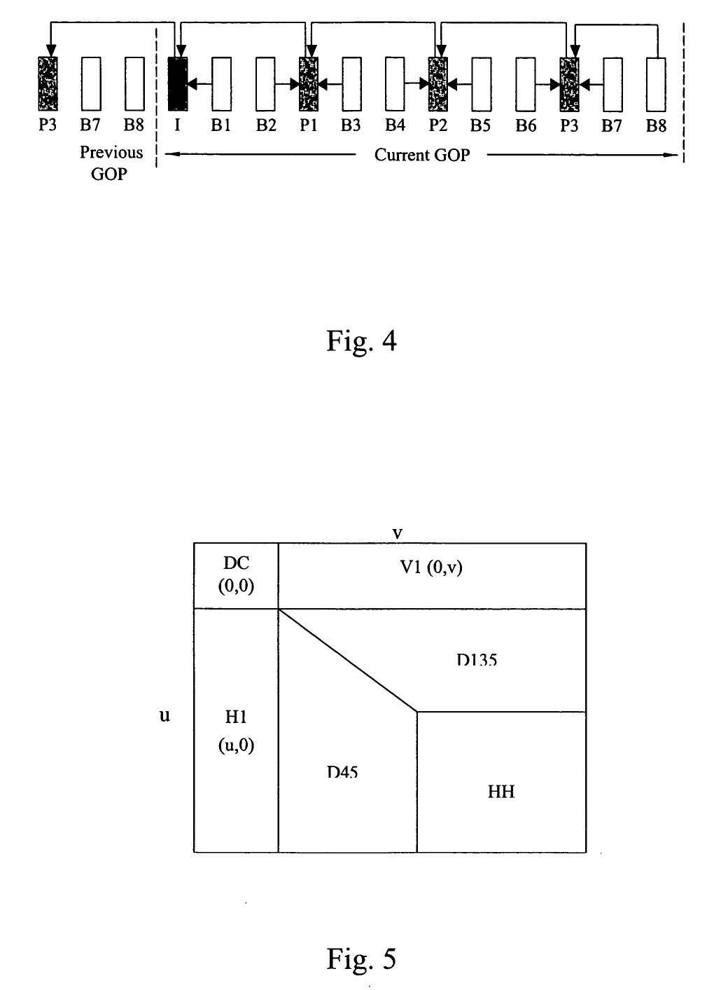

For intra-frame coding, all blocks are coded with DCT (Discrete Cosine Transform) and VLC techniques to remove spatial redundancy. In practical videos, one program consists of many various sequences, and the scene change may occur at any frame. As for the error concealment of the I-frame, whether the scene changes or not at the I-frame is first check. If the previous and current GOPs belong to the same video sequence, the P-frame of the previous GOP is applied to recover the I-frame error of the current GOP. The relative motion prediction for error concealment is illustrated in FIG. 4. If the scene just changes at the I-frame, the error concealment employs the spatial processing, such as the aforementioned spatial interpolation or bilinear interpolation, since the previous and current GOPs lack of correlation.

Based on this concept, whether the scene changes is first check from

$$MDiff = \frac{{\sum }_{i = 0}^{N - 1} ( {\sum }_{j = 0}^{15} {\sum }_{k = 0}^{15} \vert {P}_{ijk}^{prev - GOP} - {I}_{ijk}^{Cur - GOP} \vert )}{N} . \qquad ( 13 )$$

The matching difference (MDiff) between the last P frame of the previous GOP (Pᵢⱼₖ^{pre-GOP}) and the current I-frame (Iᵢⱼₖ^{Cur-GOP}) is computed with the N blocks of the first Slice (if the first slice is damaged, the next ones are checked). If the MDiff is over than a detection-threshold, it implies that the scene changes at the I-frame. In such a case, the spatial interpolation or bilinear interpolation is employed to recover the lost pixels. Otherwise, the spatial processing and the temporal compensation are adaptively computed based on temporal correlation and spatial variance. If the temporal correlation is high, one can increase the weighting of temporal compensation and decrease the weighting of spatial processing. Due to temporal compensation, high performance can be obtained for still blocks or low-motion blocks in such a case. However, if the temporal correlation is low, it implies that there are large deviations between the current and referenced frames. Accordingly, the weighting of temporal data should be greatly reduced to avoid non-matching errors, especially for high motion areas. On the other hand, the parameter of spatial variance is adopted. If the spatial variance is high, the spatial processing cannot achieve good quality for high-frequency blocks, thus the weighting of temporal result can be adaptively increased.

As for temporal compensation, an efficient method is presented to find the motion vector from the P-frame of the previous GOP to recover I-frame. If I-frame concealment motion vectors are not transmitted, the motion vector for the lost block needs to be found. The motion vector of I-frame can be computed by using median function from the vectors of neighboring blocks in the last P-frame of the previous GOP, which can be expressed as
\overline{MV}ₜ^{C}=Med.(MVₜ₋₁^{C},MVₜ₋₁^{T},MVₜ₋₁^{TL},MVₜ₋₁^{B},MVₜ₋₁^{BR},MVₜ₋₁^{BL}) (14)
where \overline{MV}ₜ^{C} denotes the motion vector of the lost block, and MVₜ₋₁^{C},MVₜ₋₁^{T},MVₜ₋₁^{TL},MVₜ₋₁^{TR},MVₜ₋₁^{B},MVₜ₋₁^{BL}, and MVₜ₋₁^{BR} denote the motion vectors of the current, the top, the top-left, the top-right, the bottom, the bottom-left and the bottom-right blocks in the previous P frame. The relative neighboring blocks of the lost block is as shown in FIG. 1, where B_{T}, B_{B}, B_{TL}, B_{TR}, B_{BL} and B_{BR} denote the top, the bottom, the top-left, the top-right, the bottom-left, and the bottom-right blocks, respectively. This is the other method to obtain the motion vector for the lost block in the present invention.

The adaptive weighting function can be computed with two parameters. One is the spatial feature with DCT coefficients of the neighboring blocks in the current I frame. The other is the motion feature from the motion vector of the previous P frame. Assumed that the DCT coefficients of the neighboring blocks are available, these coefficients can be employed to analyze the frequency distribution. FIG. 5 shows the frequency distribution in a DCT block. The first row coefficients at the V1 region represents the vertical edges, while the first column coefficients at the H1 region represents the horizontal edges. The region D45 components imply diagonal edges with 45 degree, while the region D135 components imply diagonal edges with 135 degree. If the corrupted Slice contains horizontal edges, the spatial processing is hardly to recover the horizontal edge from the adjacent Slices. Hence, the adaptive function adopts the horizontal parameter of neighboring blocks. To enhance the horizontal factor, the amplitude of horizontal components (AH) is estimated from the decoded DCT coefficients of N×N block size with

$${AH}_{lost} = C1 \times ( {\sum }_{u = 1}^{N - 1} \vert {\hat{F}}_{u0}^{T} \vert + \vert {\hat{F}}_{u0}^{B} \vert ) \qquad ( 15 )$$

where C1 is a constant. \hat{F}ᵤ₀^{T} and \hat{F}ᵤ₀^{B} are the horizontal components of the de-quantized DCT coefficients in the top and bottom blocks respectively, and the index (u,0) denotes the location of the horizontal-edge coefficients in FIG. 5.

Besides, if the block variance is high, the performance also becomes poor since the high-frequency content is not easily to recover with the spatial processing. The block variance can be easily computed with summation of all non-zero AC coefficients in DCT domain, which can be expressed by

$$BV = {\sum }_{i = 1}^{M - 1} \vert {AC}_{i} \vert \qquad ( 16 )$$

where ACᵢ is the non-zero AC coefficient that can be obtained from run-length code, and M is the number of non-zero AC coefficients. The neighboring blocks are available to estimate the block-variance (BV) parameter of the lost block, which is given by
BVₗₒₛₜ=C2×(BV_{TL}+BV_{TR}+BV_{BL}+BV_{BR}+2(BV_{T}+BV_{B})) (17)
where BV_{TL}, BV_{TR}, BV_{BL}, BV_{BR}, BV_{T} and BV_{B} denote the block variance in the adjacent top-left, top-right, bottom-left, bottom-right, top and bottom blocks. The weighting of top and bottom blocks is double since their features are closer to the processed block. Then, the parameter of spatial information (SI) can be achieved from
SIₗₒₛₜ=AHₗₒₛₜ+BVₗₒₛₜ (18)
Let AHₗₒₛₜ and BVₗₒₛₜ limit in 0˜0.4 and 0˜0.6 by adjusting C1 and C2, respectively, to set SIₗₒₛₜ value in the range of 0˜1 ( if SIₗₒₛₜ is over 1, it is set to 1). The constants C1 and C2 are decided from practical experiments to achieve the best image quality.

Moreover, the temporal parameter is estimated from the previous P-frame motion vector. While the motion speed is high, the prediction error becomes high due to non-matching errors. The motion parameter (MP) for the lost block of I-frame can be computed from the neighboring blocks of the previous P-frame as
MPₗₒₛₜ=C3×(|MV_{B}^{P}|+|MV_{T}^{P}|+|MV_{TR}^{P}|+|MV_{BT}^{P}|+|MV_{BR}^{P}|) (19)
where MVₙ^{P} denotes the motion vector of previous P-frame at the n^{th} block. The MPₗₒₛₜ value is also limited in 0˜1 by adjusting the constant C3.

Based on the spatial information and motion parameter, the adaptive function can be devised to improve the performance for error concealment. Since the video features are widely various, the weighting coefficients are computed for different images processing. As the processed block has high spatial variance or horizontal edge, the weighting of the temporal compensation is increased to improve the image resolution since the spatial processing cannot achieve good performance in this case. However, the weighting of spatial processing is increased in high-motion blocks to reduce the non-matching errors from the temporal compensation. The pixel value is adaptively computed with the spatial processing and the temporal compensation according to the estimated weighting coefficient, which can be given by
\hat{f}ᵢⱼ=(1−(SIₗₒₛₜ-MPₗₒₛₜ))×\hat{f}ᵢⱼ(S)+(SIₗₒₛₜ-MPₗₒₛₜ)×\hat{f}ᵢⱼ(T) (20)
where \hat{f}ᵢⱼ(T) and \hat{f}ᵢⱼ(S) are the interpolated results from the temporal compensation and the spatial processing, respectively. The weighting coefficient (SIₗₒₛₜ-MPₗₒₛₜ) is called as Coeff_I limited in the range of 1˜0. As a low motion block (or still block) with high spatial variance, the MPₗₒₛₜ value is small and SIₗₒₛₜ becomes large. In this case, the weighting of \hat{f}ᵢⱼ(T) is increased to improve the performance. When the motion distance becomes higher, the weighting of \hat{f}ᵢⱼ(T) and \hat{f}_{if}(S) are adaptively computed according to the spatial information and the motion parameter. In very high motion blocks, MPₗₒₛₜ values would be higher, and then, the weighting of \hat{f}ᵢⱼ(T) is greatly reduced to reduce non-matching errors.

For P-frames error concealment, three P-pictures are needed to process in the current GOP. The motion vector of the first P-frame, denoted as P1, is computed from the motion vectors of neighboring blocks since its reference is I-frame that cannot provide motion parameters. The median function is presented to find the lost motion vector from neighboring available vectors as
\overline{MV}ₜ^{C}=Med.(MVₜ^{A},MVₜ^{T},MVₜ^{TR},MVₜ^{TL},MVₜ^{B},MVₜ^{BR},MVₜ^{BL}) (21)
where \overline{MV}ₜ^{C} denotes the motion vector of the lost block, MVₜ^{A}=(MVₜ^{T}+MVₜ^{B})/2 is an average vector of the top and bottom blocks, and MVₜ^{T},MVₜ^{TR},MVₜ^{B},MVₜ^{BR} and MVₜ^{BL} denote the motion vectors of the top, the top-right, the top-left, the bottom, the bottom-right and the bottom-left blocks in the current P frame.

As recovery for the second and the third P-frames, denoted as P2 and P3, first compute the temporal motion distance among the available neighboring blocks of the current and reference frames. The median function is taken by
\overline{MV}ₜ^{C}=Med.(MVₜ₋₁^{C},MVₜ^{T},MVₜ^{TR},MVₜ^{TL},MVₜ^{B},MVₜ^{BR},MVₜ^{BL}) (22)
where \overline{MV}ₜ^{C} denotes the motion vector of the lost block, MVₜ₋₁^{C} is the motion vector of the current block in the same position of the previous P-frame, and MVₜ^{T}, MVₜ^{TR}, MVₜ^{TL}, MVₜ^{B}, MVₜ^{BR}, MVₜ^{BL} denote the motion vectors of the top, the top-right, the top-left, the bottom, the bottom-right and the bottom-left blocks in the current P frame. However, if a large area of the P frame is corrupted, then, the use of the median motion vector of the current frame is no longer valid. In this case, the motion vector from the previous frame can be used. The scheme is similar to the proposed method for the I-frame concealment.

For P-framne error concealment, an adaptive function is also used to modify the weighting of the temporal and spatial results. In MPEG inter-coding scheme, the difference of inter-blocks is coded with DCT. The amount of the residual DCT coefficients implies the difference of the current coded block and the matched block. Clearly, the residual DCT coefficients of neighboring available blocks are useful to estimate the parameter of the frame correlation. The block deviation (BD) is computed from the quantized DCT coefficients with

$$BD = {\sum }_{u = 0}^{N - 1} {\sum }_{u = 0}^{N - 1} \vert {\tilde{F}}_{uv} \vert \qquad ( 23 )$$

The BD value represents the block correlation. Then, the BD parameter for a lost block can be estimated from the DCT coefficients of neighboring blocks by
BDₗₒₛₜ=C4×(BD_{TL}+BD_{TR}+BD_{BL}+BD_{BR}+2(BD_{T}+BD_{B})),1≧BDₗₒₛₜ≧0, (24)
where C4 is a normalized constant to limit BDₗₒₛₜ in the range of 1 to 0. BDₙ implies the block deviation for the n^{th} block. Then, the adaptive function can be determined by
\hat{f}ᵢⱼ=(1−BDₗₒₛₜ)×\hat{f}ᵢⱼ(T)+BDₗₒₛₜ×\hat{f}ᵢⱼ(S). (25)
where BDₗₒₛₜ is called as coeff_P. If the BDₗₒₛₜ level is small, the recovery pixels almost come from the motion compensation since the correlation of inter-blocks is high. However, while the current and previous blocks have large differences, the temporal correlation would become low and the estimated BDₗₒₛₜ value would become large accordingly. The equation (25) can adaptively increase the weighting of spatial processing to reduce the matching errors.

In additional, the error concealment algorithm also can solve the problem of scene change. If the scene just changes at the P-frame, the current block and the reference block will have large deviations. The estimated BD level would be very high due to no correlations between inter-frames. The adaptive function from equation (25) can automatically reduce the temporal weighting to zero. Therefore, the result comes from the spatial processing in this case. Although the spatial processing blurs image edges, it can avoid non-matching errors. The same way is used for B-frames processing. The block deviation is computed with equation (23) from the previous reference frame and the next reference frame, respectively. The previous or the next frame as the reference frame is selected from a smaller block deviation for the B-frame error concealment. Then, the processing flow of B-frames is the same as P-frame with equation (23) to equation (25).

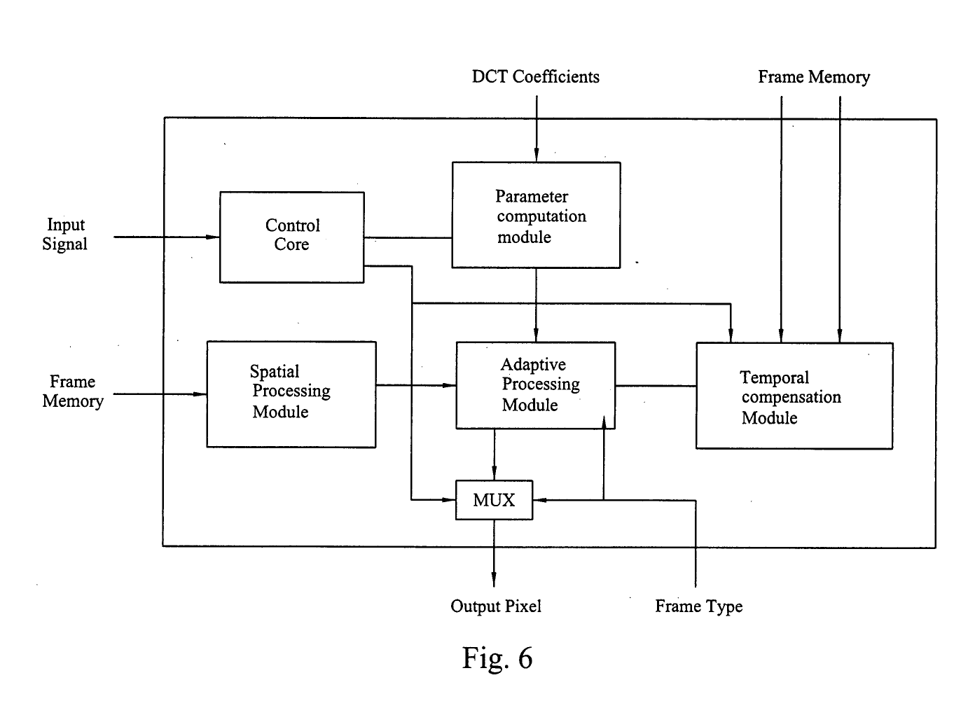

FIG. 6 illustrates the apparatus for error concealment of the preferred embodiment of the present invention. The apparatus receives an input signal from the error flag and Slice start code to identify which macro-block is error and the frame type in the control core. Then, DCT coefficients are extracted from the video decoder and these parameters are computed in the parameter computation module to derive at least a coefficient for the weighting in an adaptive processing. The neighboring motion vectors are read from a frame memory to compute the motion vectors of the processed block for PB-frame and I-frame, respectively, in the temporal compensation module. Then, a result of the temporal compensation is obtained. The result can be derived from equation (11) by the minimum vector distance, or from equation (14) and equation (21) by median function. Meanwhile, for spatial processing, spatial data, such as the boundary pixel, is read from another frame memory and is stored to the on-chip line buffer for real-time implementation. The spatial processing module computes spatial data to obtain a result of the spatial processing. The result can be derived from aforementioned spatial interpolation or by bilinear interpolation. With the coefficient for the weighting and the results of the spatial processing and the temporal compensation, the adaptive processing module proceeds the adaptive computation in accordance with the equation (20) for I-frame and equation (25) for PB-frames, respectively, and acquires one corrected pixel. Afterwards, a multiplexer outputs the corrected pixel in the error macro-block per cycle.

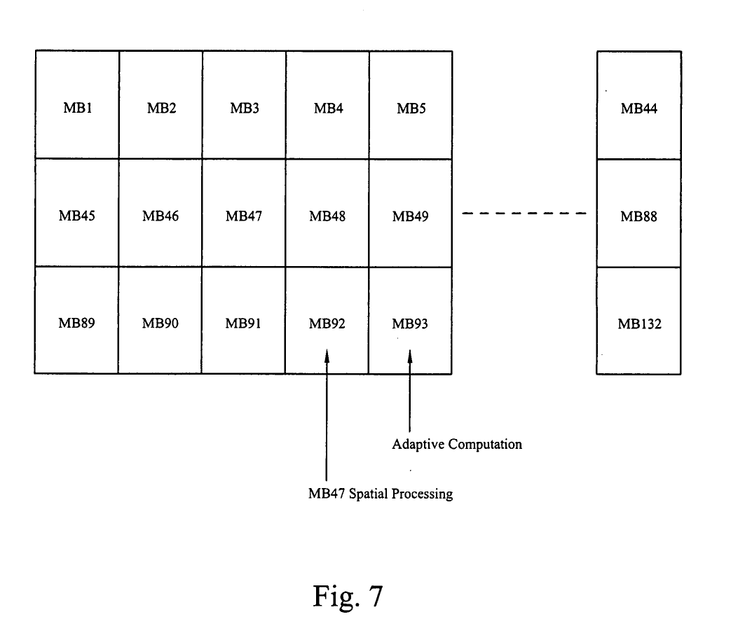

FIG. 7 illustrates the computation schedule of the spatial processing. In the video coding system, the minimum synchronization point uses GOB or Slice that is a set of macro blocks (MB). If any macro block is corrupted in the current Slice, the next decoding macro blocks in the same Slice will all be error. As shown in FIG. 7, the errors occurred at the 47th MB and this error Slice ends at 88th MB. Then, the next Slice is decoded in normal. The computation schedule of the spatial processing for the 47th MB is in decoding the 92th MB since the 91th MB pixel data is needed. As decoding the 93th MB, the 47th MB can be sent with pixel-by-pixel after error concealment by taking adaptive computation of the spatial processing and the temporal compensation. For the purpose of error concealment, the current decoding Slice must be buffered in the temporal memory. This error concealment Slice will be output when decoding the next Slice. From FIG. 7, the system output delays one Slice and two macro-blocks. Therefore, the error concealment chip requires large memory to buffer the decoding blocks.

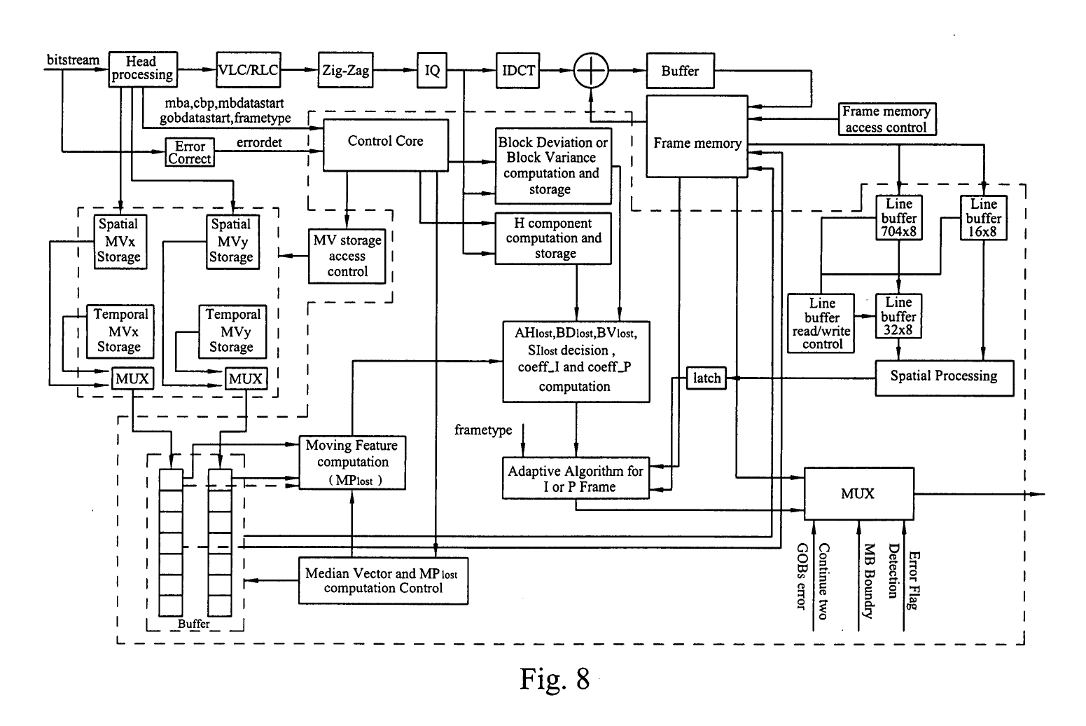

FIG. 8 illustrates the implementation of the present invention in an error concealment chip. The system architecture comprises a video decoder, and the error concealment chip. The frame type is determined from head processing while the video stream is decoded. Moreover, the position of the error block also can be found according to the decoded parameters of the mba (Macro-block Address), cbp(Code Block Pattern) and start code. These decoded signals are sent to the control core in order to control each computational module. The DCT coefficients are extracted from the decoder to decide the block deviation for PB frames and the block variance and spatial information for I-frame. The coefficients for the weighting in an adaptive computation for the I-frame or PB-frames are derived. The decoding motion vectors of the previous frame and the current frame are stored on the temporal memory off-chip. The vector is read to the on-chip buffer and then to derive the result of the temporal compensation for PB-frames or I-frame. Meanwhile, the chip reads the frame memory to line-buffer for spatial processing. For real-time implementation, the last row of the top block is stored at H-line buffers (H is the horizontal sampling number), where the line buffer is realized with embedded memory. If 4CIF format is used, 704×8 memory cells are required for an 8-bit pixel. The first row of the current decoding block is stored on the temporal buffers with 16×8 registers from IDCT results. One spatial pixel is interpolated per cycle and then, it is latched at 16×16 registers on-chip. As the time schedule goes to the next block, the error pixel is corrected by taking the adaptive computations with the coefficients for the weighting, the result of the spatial processing and the result of the temporal compensation from the frame memory. The output of this chip is from a multiplexer. Furthermore, the error flag is detected whether it is high. If the error flag is low, it implies there are no errors for the decoding data, and then, the frame memory is directly read. Otherwise, the corrected pixel from the adaptive processing is sent to the output as the error flag is found. Moreover, if the position of the error macro-block is located at the boundary or two continuous error Slices (or GOBs) are found, the chip uses the temporal compensation from frame memory via the previous vector instead of the adaptive processing, since the spatial processing quality becomes poor in such two cases.

Please refer to FIG. 7 and FIG. 8. When the decoding timing schedule of the computational kernel runs to the 91th MB, the parameters of AH, BV and BD from DCT coefficients for 47^{th} MB recovery are computed. Since one MB consists of four 8×8-blocks for Y signal, the DCT coefficients from four blocks are accumulated to compute these parameters. For real-time operation, all computations for one MB must be finished during 256 clocks since the size of the MB is 16×16. To achieve this purpose, pipeline schedule is employed to solve the timing constrain. Since the line-buffer designed with embedded memory has more limitations for data access, the partial data is preloaded to the on-chip registers. As the decoding time runs to the 92th MB, the last row of the 3th MB and the first row of the 91th MB have been stored at the 32×8 line-buffer and 16×8 line-buffer, respectively. The spatial pixel is computed with aforementioned spatial interpolation or bilinear interpolation for the 47^{th} MB, and the results are latched at the on-chip memory. Since each MB has 256 pixels, 256 clocks are spent to interpolate them. Meanwhile, the motion vector for the temporal compensation is estimated in this period. For median vector searching, first 7 vectors are loaded to the register with 7 clocks. With simple looping search, the median vector can be estimated with 21 clocks and its result is latched. To process one macro block, 256 clocks are admitted. The temporal compensation is not a critical path in the chip since it only uses 28 clocks in total. According to this motion vector, the 16 pixels are pre-loaded from frame memory data to 16 registers on chip to reduce the access time. When decoding the 93th MB, available pixels for the 47th MB are output with the adaptive computation of the spatial pixels and temporal compensation results. Thus, the chip can output one pixel per cycle for real-time operation.

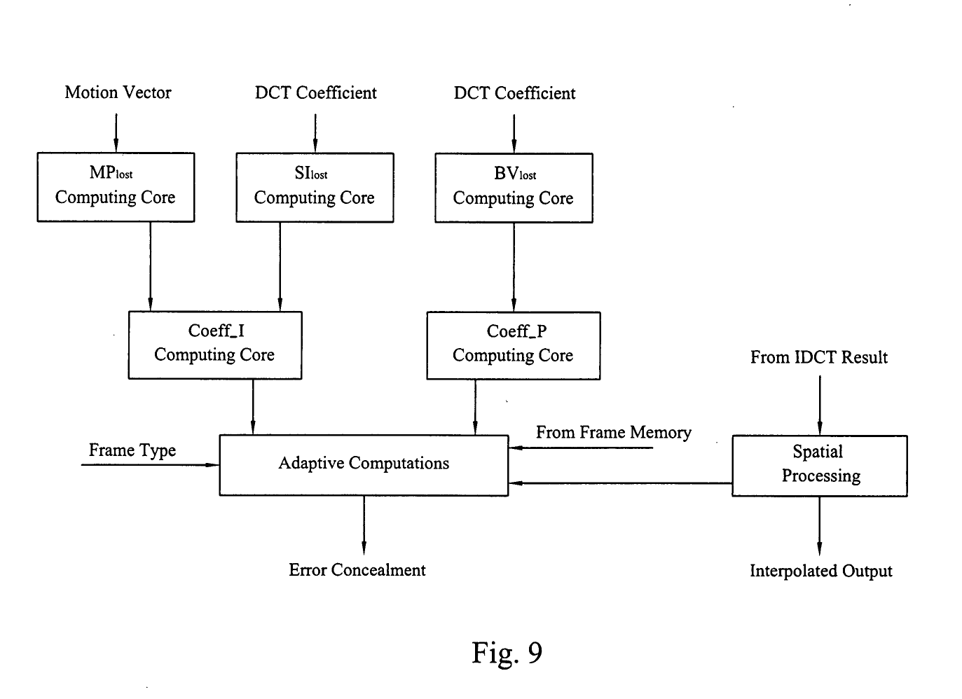

FIG. 9 illustrates the test structure of the preferred embodiment of the present invention. For testable measures, each computational path is needed to isolate to verify the function for a physical testing since the system has multi-path processing flow. This test structure has two output ports. One is for the adaptive fumction and the other is for the spatial processing output. There are two purposes to plan the spatial processing output. One is that the user can select the spatial processing output when the decoder operates in frame skipping mode for fast forward/backward searching since the temporal correlation is very low. The other is that for testable measures, the computational core and line buffer can be verified from the spatial processing output. If the result of the adaptive computation does not meet the expectation, the computational path in which error occurs will be found. Zeros can be input to the spatial processing module from IDCT result port, and the frame type of P is decided to verify the computational path coeff_P and its adaptive function with equation (25) from the output. SIₗₒₛₜ, coeff_I and adaptive function computational core can also be verified as the frame type used I and the input motion vector used zeros. In the same way, the MPₗₒₛₜ computational core can be verified using zero DCT coefficients as input. With these approaches, one can find which one computational circuit is error for the prototyped chip testing.

As is understood by a person skilled in the art, the foregoing preferred embodiments of the present invention are illustrative of the present invention rather than limiting of the present invention. It is intended that various modifications and similar arrangements are covered within the spirit and scope of the appended claims, the scope of which should be accorded the broadest interpretation so as to encompass all such modifications and similar structures.

What is claimed is:

1. An apparatus for error concealment, the apparatus comprising:
a control core, receiving an input signal and identifying an error macro-block in a column of slice of a frame and a frame type of the frame;
a parameter computation module, electrically connecting to the control core, the parameter computation module receiving a plurality of DCT coefficients and temporal data to derive at least a coefficient for the weighting in an adaptive computation for the frame;
a temporal compensation module, electrically connecting to the control core, the temporal compensation module computing the temporal data to obtain a result of the temporal compensation;
a spatial processing module, electrically connecting to the control core, the spatial processing module computing spatial data to obtain a result of the spatial processing; and
an adaptive processing module, electrically connecting to the control core, the adaptive processing module proceeding the adaptive computation with the coefficient for the weighting derived by the parameter computation module, the result of the temporal compensation and the result of the spatial processing to obtain a result of the adaptive processing.

2. The apparatus for error concealment of claim 1, further comprising a multiplexer for outputting a normal pixel, or the result of the temporal compensation, the result of the spatial processing, or the result of the adaptive processing as a corrected pixel in the error macro-block.

3. The apparatus for error concealment of claim 2, wherein the multiplexer determines the outputting of the normal pixel or the corrected pixel in the error macro-block according to an error flag signal, the value of matching difference, and the position of the error macro-block.

4. The apparatus for error concealment of claim 1, further comprising at least a line buffer to store the spatial data.

5. The apparatus for error concealment of claim 1, further comprising at least a register to store the temporal data.

6. A method for error concealment, the method comprising:
receiving an input signal and identifying an error macro-block in a column of slice of a frame and a frame type of the frame;
extracting a plurality of DCT coefficients from a decoder and accessing temporal data to derive at least a coefficient for the weighting in an adaptive computation for the frame;
computing the temporal data to obtain a result of the temporal compensation, and computing spatial data to obtain a result of the spatial processing; and
proceeding the adaptive computation with the coefficient for the weighting, the result of the temporal compensation and the result of the spatial processing, and generating a result of the adaptive processing.

7. The method for error concealment of claim 6, further comprising outputting a normal pixel, or the result of the temporal compensation, the result of the spatial processing, or the result of the adaptive processing as a corrected pixel in the error macro-block.

8. The method for error concealment of claim 7, wherein the normal pixel is output if an error flag signal is detected low.

9. The method for error concealment of claim 7, wherein the result of the temporal compensation is output as the corrected pixel in the error macro-block if the error macro-block is located at the boundary or a plurality of errors occur in continuous slices.

10. The method for error concealment of claim 7, wherein the result of the spatial processing is output as the corrected pixel in the error macro-block if the value of matching difference is greater than a threshold.

11. The method for error concealment of claim 6, further comprising inputting a plurality of macro-blocks of a next column of slice when the error macro-block is computed.

12. The method for error concealment of claim 11, wherein the frame is an I-frame, and the step of proceeding the adaptive computation is in accordance with the equation:
\hat{f}ᵢⱼ=(1−(SIₗₒₛₜ-MPₗₒₛₜ))×\hat{f}ᵢⱼ(S)+(SIₗₒₛₜ-MPₗₒₛₜ)×\hat{f}ᵢⱼ(T), where \hat{f}ᵢⱼ(T) and \hat{f}ᵢⱼ(S) are the result of the temporal compensation and the result of the spatial processing, respectively, and the weighting coefficient (SIₗₒₛₜ-MPₗₒₛₜ) is the coefficient derived after the step of extracting the DCT coefficients and accessing temporal data.

13. The method for error concealment of claim 12, wherein the SIₗₒₛₜ in the weighting coefficient is the parameter of spatial information of the error macro-block derived from the amplitude of horizontal components (AHₗₒₛₜ) and the block variance (BVₗₒₛₜ) of the error macro-block by the equation: SIₗₒₛₜ=AHₗₒₛₜ+BVₗₒₛₜ, and the MPₗₒₛₜ in the weighting coefficient is the parameter of motion parameter of the error macro-block derived from neighboring blocks of a previous P-frame by the equation: MPₗₒₛₜ=C1×(|MV_{B}^{P}|+|MV_{T}^{P}|+|MV_{TR}^{P}|+|MV_{BT}^{P}|+|MV_{BR}^{P}|), where C1 is a constant, and MVₙ^{P} denotes the motion vector of the previous P-frame at the n^{th} block.

14. The method for error concealment of claim 13, wherein the amplitude of horizontal components of the error macro-block (AHₗₒₛₜ) is estimated from the DCT coefficients with the equation:
$${AH}_{lost} = C2 \times ( {\sum }_{u = 1}^{N - 1} \vert {\hat{F}}_{u0}^{T} \vert + \vert {\hat{F}}_{u0}^{B} \vert ) ,$$
where C2 is a constant, and \hat{F}ᵤ₀^{T} and \hat{F}ᵤ₀^{B} are horizontal components of the DCT coefficients in the top and bottom blocks of the error macro-block, and the block variance of the error macro-block (BVₗₒₛₜ)is computed from neighboring blocks of the error macro-block by the equation: BVₗₒₛₜ=C3×(BV_{TL}+BV_{TR}+BV_{BL}+BV_{BR}+2(BV_{T}+BV_{B})), where C3 is a constant, and BV_{TL}, BV_{TR}, BV_{BL}, BV_{BR}, BV_{T} and BV_{B} denote the block variance of the top-left, the top-right, the bottom-left, the bottom-right, the top and the bottom blocks of the error macro-block.

15. The method for error concealment of claim 14, wherein the DCT coefficients comprises the block variance computed with summation of all non-zero AC coefficients in DCT domain by the equation:
$$BV = {\sum }_{i = 1}^{M - 1} \vert A {C}_{i} \vert ,$$
where ACᵢ is the non-zero AC coefficient that can be obtained from run-length code, and M is the number of non-zero AC coefficients.

16. The method for error concealment of claim 11, wherein the frame is a P-frame or a B-frame, and the step of proceeding the adaptive computation is in accordance with the equation: \hat{f}ᵢⱼ=(1−BDₗₒₛₜ)×\hat{f}ᵢⱼ(T)+BDₗₒₛₜ×\hat{f}ᵢⱼ(S), where \hat{f}ᵢⱼ(T) and \hat{f}ᵢⱼ(S) are the result of the temporal compensation and the result of the spatial processing, respectively, and the weighting coefficient BDₗₒₛₜ is the coefficient derived after the step of extracting the DCT coefficients.

17. The method for error concealment of claim 16, wherein the weighting coefficient BDₗₒₛₜ is the block deviation of the error macro-block estimated from the DCT coefficients of neighboring blocks by the equation:
BDₗₒₛₜ=C4×(BD_{TL}+BD_{TR}+BD_{BL}+BD_{BR}+2(BD_{T}+BD_{B})),1≧BDₗₒₛₜ≧0, where C4 is a constant, and the block deviation (BD) is computed from the DCT coefficients with the equation:
$$BD = {\sum }_{u = 0}^{N - 1} {\sum }_{u = 0}^{N - 1} \vert {\tilde{F}}_{uv} \vert .$$

18. The method for error concealment of claim 11, wherein the frame is an I-frame, and the result of the temporal compensation is obtained by a median function from the equation:
\overline{MV}ₜ^{C}=Med.(MVₜ₋₁^{C},MVₜ₋₁^{T},MVₜ₋₁^{TL},MVₜ₋₁^{B},MVₜ₋₁^{BR},MVₜ₋₁^{BL}), where \overline{MV}ₜ^{C} denotes the motion vector of the error macro-block, and MVₜ₋₁^{C},MVₜ₋₁^{T},MVₜ₋₁^{TL},MVₜ₋₁^{TR},MVₜ₋₁^{B},MVₜ₋₁^{BL}, and MVₜ₋₁^{BR} denote the motion vectors of the current, the top, the top-left, the top-right, the bottom, the bottom-left and the bottom-right blocks of the error macro-block in a previous P frame.

19. The method for error concealment of claim 11, wherein the frame is an I-frame, and the result of the temporal compensation is obtained from a rule according to a temporal distance and a local vector distance, the rule comprising:
if the temporal distance is less than a first threshold, motion vector for lost block is attained from the motion vector of previous frame in the same locations; and
if the temporal distance is larger than the first threshold and the local vector distance is less than a second threshold, the motion vector is obtained from the average of the local vector distance.

20. The method for error concealment of claim 19, wherein the rule further comprising:
if the temporal distance is larger than the first threshold and the local vector distance is larger than the second threshold, the motion vector is obtained from the average vector of current and the previous frame with referring to the equation:
$$MV ( \hat{x} , \hat{y} ) = ( \frac{{Mv}_{t}^{{B}_{TL}} + {Mv}_{t}^{{B}_{T}} + {Mv}_{t}^{{B}_{TR}} + {Mv}_{t}^{{B}_{BR}} + {Mv}_{t}^{{B}_{B}} + {Mv}_{t}^{{B}_{BL}} + 2 {Mv}_{t - 1}^{{B}_{C}}}{8} ) ,$$
where MV(\hat{x}, ŷ) denotes the motion vector of the error macro-block, and Mvₜ^{B}^{_{TL}},Mvₜ^{B}^{_{T}},Mvₜ^{B}^{_{TR}},Mvₜ^{B}^{_{BR}},Mvₜ^{B}^{_{B}}, and Mvₜ^{B}^{_{BL}} denote the motion vectors of the top-left, the top, the top-right, the bottom-right, the bottom and the bottom-left blocks of the error macro-block in the current frame, and Mvₜ₋₁^{B}^{_{C}} denotes the motion vector of the current block in a previous frame.

21. The method for error concealment of claim 11, wherein the frame is a P-frame or a B-frame, and the result of the temporal compensation is obtained from neighboring available vectors by a median function from the equation:
\overline{MV}ₜ^{C}=Med.(MVₜ^{A},MVₜ^{T},MVₜ^{TR},MVₜ^{TL},MVₜ^{B},MVₜ^{BR},MVₜ^{BL}), where \overline{MV}ₜ^{C} denotes the motion vector of the error macro-block, MVₜ^{A}=(MVₜ^{T}+MVₜ^{B})/2 is an average vector of the top and bottom blocks of the error macro-block, and MVₜ^{T},MVₜ^{TR},MVₜ^{B},MVₜ^{BR} and MVₜ^{BL} denote the motion vectors of the top, the top-right, the top-left, the bottom, the bottom-right and the bottom-left blocks of the error macro-block in the current P frame or B frame.

22. The method for error concealment of claim 11, wherein the frame is a second P-frame or a third P-frame, and the result of the temporal compensation is obtained by a median function from the equation:
\overline{MV}ₜ^{C}=Med.(MVₜ₋₁^{C},MVₜ^{T},MVₜ^{TR},MVₜ^{TL},MVₜ^{B},MVₜ^{BR},MVₜ^{BL}), where \overline{MV}ₜ^{C} denotes the motion vector of the error macro-block, MVₜ₋₁^{C} denotes the motion vector of the current block in the same position of the previous P frame, and MVₜ^{T}, MVₜ^{TR}, MVₜ^{TL}, MVₜ^{B}, MVₜ^{BR}, MVₜ^{BL} denote the motion vectors of the top, the top-right, the top-left, the bottom, the bottom-right and the bottom-left blocks of the error macro-block in the current P frame.

23. The method for error concealment of claim 11, wherein the spatial processing can be a bilinear interpolation.

24. The method for error concealment of claim 11, wherein the spatial processing can be a spatial interpolation method comprising:
using block boundary matching between the neighboring blocks of the error macro-block to find the edge direction for the error macro-block, and getting a plurality of results of the mean absolute difference (MAD);
finding a first best vector of a first best match (BMA) between a bottom block B_{B} and a top-left block B_{TL}, a top block B_{T}, and a top-right block B_{TR} of the error macro-block by the minimum MAD value;
interpolating at least a first corrected pixel along the direction of the first best vector with weighting linear interpolation;
finding a second best vector of a second best match between the top block B_{T} and the bottom block B_{B}, a bottom-left block B_{BL}, and a bottom-right block B_{BR} of the error macro-block by the minimum MAD value;
interpolating at least a second corrected pixel along the direction of the second best vector with weighting linear interpolation; and
merging the first corrected pixel and the second corrected pixel.

25. The method for error concealment of claim 24, wherein the step of using block boundary matching is referring to the equation:
$$MAD ( M x ) = {\sum }_{i = 0}^{N - 1} \vert {f}_{0 , i}^{{B}_{B}} - {f}_{N - 1 , i + Mx}^{{B}_{TL} , {B}_{T} , {B}_{TR}} \vert ,$$
where Mx is a search vector that is from −N to N if the block size is N×N.

26. The method for error concealment of claim 24, wherein the step of interpolating the first corrected pixel with weighting linear interpolation is referring to the equation:
$${\hat{f}}_{m1 , n1}^{1} = {f}_{N - 1 , i}^{{B}_{TL} , {B}_{T} , {B}_{TR}} \times \frac{d2}{M} + {f}_{0 , k}^{{B}_{B}} \times \frac{d1}{M} ,$$
where d1 and d2 are the distances between the interpolated pixel to the best matching boundary and to the bottom block.

27. The method for error concealment of claim 24, wherein the step of interpolating the second corrected pixel with weighting linear interpolation is referring to the equation:
$${\hat{f}}_{m2 , n2}^{2} = {f}_{0 , i}^{{B}_{BL} , {B}_{B} , {B}_{BR}} \times \frac{d1}{M} + {f}_{N - 1 , k}^{{B}_{T}} \times \frac{d2}{M} ,$$
where d1 and d2 are the distances between the interpolated pixel to the best matching boundary and to the top block.

28. The method for error concealment of claim 24, wherein the step of merging the first corrected pixel and the second corrected pixel is referring to the equation:
$$If {f}_{m1 , n1}^{l} \neq 0 and {f}_{m2 , n2}^{2} = 0 , {\hat{f}}_{m , n} = {f}_{m1 , n1}^{1}$$
$$Elseif {f}_{m1 , n1}^{l} = 0 and {f}_{m2 , n2}^{2} \neq 0 , {\hat{f}}_{m , n} = {f}_{m2 , n2}^{2}$$
$$Elseif {f}_{m1 , n1}^{1} \neq 0 and {f}_{m2 , n2}^{2} \neq 0 , {\hat{f}}_{m , n} = \frac{{f}_{m1 , n1}^{1} + {f}_{m2 , n2}^{2}}{2}$$

29. The method for error concealment of claim 24, further comprising:
using a median filter or an overlap boundary search for at least a residual error pixel.

30. The method for error concealment of claim 6, wherein the step of proceeding the adaptive computation is computed during one clock and the result of the adaptive processing is latched to a register.

31. The method for error concealment of claim 6, further comprising a testable measure method to find a fault path, the testable measure method comprising:
verifying a spatial processing module and a line buffer from a spatial processing output;
inputting zeros to the spatial processing module and making the frame type to be P frame to verify a computational path coeff_P and an adaptive computation function from an adaptive computation output;
inputting zeros to a computational core MPₗₒₛₜ and making the frame type to be I frame to verify a computational core SIₗₒₛₜ, a computational path coeff_I, and the adaptive computation function from the adaptive computation output; and
inputting zeros to the computational core SIₗₒₛₜ and making the frame type to be I frame to verify the computational core MPₗₒₛₜ, the computational path coeff_I, and the adaptive computation function from the adaptive computation output.
